(19) United States
(12) Patent Application Publication
(10) Pub. No.: US 2013/0134697 A1
(43) Pub. Date: May 30, 2013

(54) AIRBAG APPARATUS FOR VEHICLE

(71) Applicants: Jun Yeol Choi, Seoul (KR); Hyo Shub Shin, Hwaseong-si (KR)

(72) Inventors: Jun Yeol Choi, Seoul (KR); Hyo Shub Shin, Hwaseong-si (KR)

(73) Assignee: Hyundai Motor Company, Seoul (KR)

(21) Appl. No.: 13/479,721

(22) Filed: May 24, 2012

(30) Foreign Application Priority Data
Nov. 28, 2011 (KR) 10-2011-0125036

(51) Int. Cl. B60R 21/2338; B60R 21/239

(52) U.S. Cl. 280/743.2

(57) ABSTRACT

An airbag apparatus for a vehicle may include a vent hole formed on an airbag cushion to discharge an expanding gas inside of the airbag cushion, a cover attached on the outside of the airbag and selectively covering the vent hole, a rope, one end of which may be fixed to the inside of the airbag cushion and the other end of which may be fixed to the cover through the vent hole to provide a tensile force to the cover such that the cover opens or closes the vent hole according to the tensile force applied to the cover via the rope, and a rope-guide attached to the inside of the airbag cushion and upholding the rope to the airbag cushion, wherein the rope may be slidably engaged to the rope-guide and a section of the rope may be aligned longitudinally in the airbag cushion.

### CROSS-REFERENCE TO RELATED APPLICATION

The present application claims priority to Korean Patent Application No. 10-2011-0125036 filed on Nov. 28, 2011, the entire contents of which is incorporated herein for all purposes by this reference.

### BACKGROUND OF THE INVENTION

1. Field of the Invention

The present invention relates to an airbag apparatus for a vehicle. More particularly, it relates to a vent configuration for discharging properly an expanding gas of an airbag cushion.

2. Description of Related Art

Generally, an airbag serves to loosen an impact applied to the occupant so as to reduce or prevent damage through a proper expansion when a vehicle accident occurs wherein an expansion behavior of the airbag plays an important role in ensuring safety of an occupant.

Especially, the requested expansion behavior of the airbag is to hold the occupant fast by rapid expansion at the beginning of a deployment and to discharge properly expanding gas inside the airbag cushion at loading when occupant begins to contact the airbag cushion and apply the load thereto so as to protect the occupant properly.

Furthermore, in order to satisfy requirements of the rules such as the Low Risk Deployment rule of North America, and in the cover of the LRD requirements, it requires that airbag cushion should discharge an expanding gas through a vent hole at the beginning of the deployment of the airbag so as to minimize the damage of an child or the occupant adjacent to the airbag apparatus. Hereinafter, LRD performance refers to a performance to satisfy the LRD requirements.

In addition, in order to satisfy the LRD performance, a part of a vent hole should be open even at the beginning of the deployment of the airbag so that airbag cushion could discharge an expanding gas therethrough, a vent hole should be closed so far as possible for fast expansion of the airbag cushion at the beginning of the deployment of the airbag cushion and a vent hole should be open when the occupant is loaded to the airbag at the time of full expansion of the airbag cushion so that the expanding gas is discharged. However, it is not easy to realize such a configuration that a vent hole is properly opened and closed in accordance with a progress of a deployment of an airbag and seating condition of an occupant.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an airbag apparatus of a vehicle with low cost and simple configuration which is deployed rapidly at the beginning of the deployment of the airbag cushion, satisfies proper loosening performance when occupant is loaded to the airbag cushion and satisfies the LRD performance to reduce damage to a child or occupant who is nearly located to the airbag.

In an aspect of the present invention, an airbag apparatus for a vehicle may include a vent hole formed on an airbag cushion to discharge an expanding gas inside of the airbag cushion, a cover attached on the outside of the airbag and selectively covering the vent hole, a rope, one end of which is fixed to the inside of the airbag cushion and the other end of which is fixed to the cover through the vent hole to provide a tensile force to the cover such that the cover opens or closes the vent hole according to the tensile force applied to the cover via the rope, and a rope-guide attached to the inside of the airbag cushion and upholding the rope to the airbag cushion, wherein the rope is slidably engaged to the rope-guide and a section of the rope is aligned longitudinally in the airbag cushion.

The one end of the rope is fixed on a front of the airbag cushion, and the rope guide is mounted on a rear of the airbag cushion on the inside of the airbag cushion such that an occupant's head is in contact with the rear of the airbag cushion.

Both sides of the rope guide are sewed at the airbag cushion with slidably surrounding the rope between the both sides and an inner surface of the airbag together.

The cover is shaped of a pocket, a part of which is connected to the airbag cushion and the other part is disconnected from the airbag cushion so that the expanding gas discharged from the vent hole is released to the outside of the airbag cushion through the pocket.

The cover is shaped of a trapezoid of which a triangle is connected to both sides of a quadrangle so as to make a space for the quadrangle apart from an outer surface of the airbag cushion by a triangle connected to the both sides of the quadrangle, and hypotenuses of the triangle which narrows toward the quadrangle and a side of the quadrangle connecting the hypotenuses surround around the vent hole and are connected directly to the airbag cushion and the other sides which the triangle and the quadrangle meet are freely open apart from the airbag cushion.

The cover may include a central part formed larger than the vent hole and covering the vent hole, and a plurality of legs connecting the central part to an outer surface of the airbag cushion, wherein the expanding gas discharged from the vent hole is released through space formed between the legs.

The other end of the rope is connected to an inner surface of the central part of the cover through the vent hole.

A plurality of the rope guides are mounted on the different positions of the airbag cushion to surround and slidably uphold the rope.

At least two rope guides of the rope guides are mounted on a rear of the airbag cushion, and one of the at least two rope guides is positioned above another of the at least two rope guides.

The one of the at least two rope guides is mounted on a position of the airbag cushion where a usual adult's head M sitting contacts and the another of the at least two rope guides is mounted on a position of the airbag cushion where a usual child's head M sitting contacts respectively.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a configuration of an airbag apparatus according to an exemplary embodiment of the present invention.

FIG. 2 is a development view illustrating main components of the airbag apparatus shown in FIG. 1.

FIG. 3 is a cross-sectional view illustrating the airbag cushion from above to explain a situation at the beginning of deployment of the airbag cushion shown in FIG. 1.

FIG. 4 is a view illustrating a situation an occupant's head contacts to the airbag cushion shown in FIG. 1.

FIG. 5 is a view illustrating the airbag cushion shown in FIG. 1 which satisfies the LRD performance.

FIG. 6 is a view illustrating the airbag apparatus according to another embodiment of the present invention.

FIG. 7 is a development view illustrating main components of the airbag apparatus shown in FIG. 6.

FIG. 8 is a view illustrating a situation at the beginning of deployment of the airbag cushion shown in FIG. 6.

FIG. 9 is a view illustrating a situation an occupant's head contacts to the airbag cushion shown in FIG. 6.

FIG. 10 is a view illustrating an airbag apparatus according to another exemplary embodiment of the present invention, which implements the further improved LRD performance.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail to various embodiments of the present invention, examples of which are illustrated in the accompanying drawings and described below.

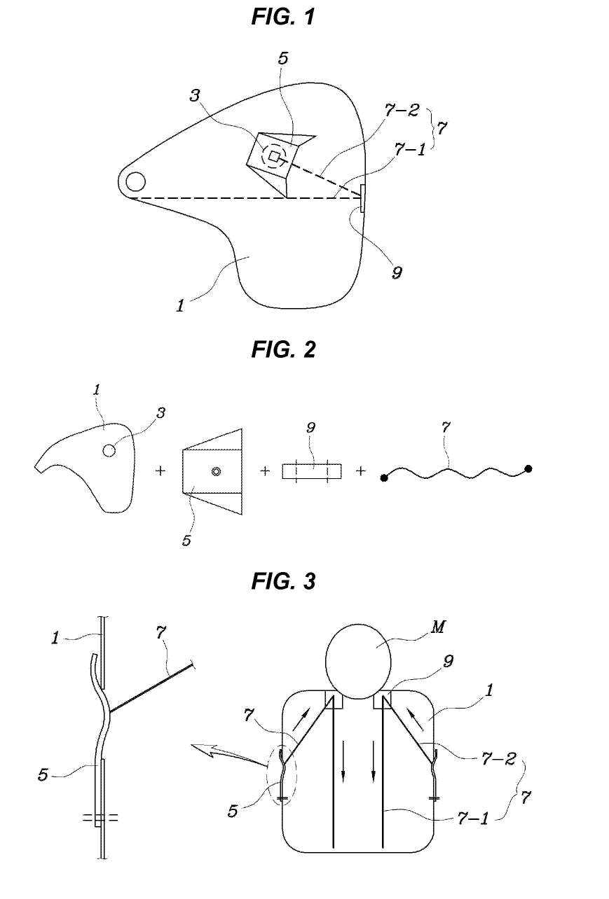

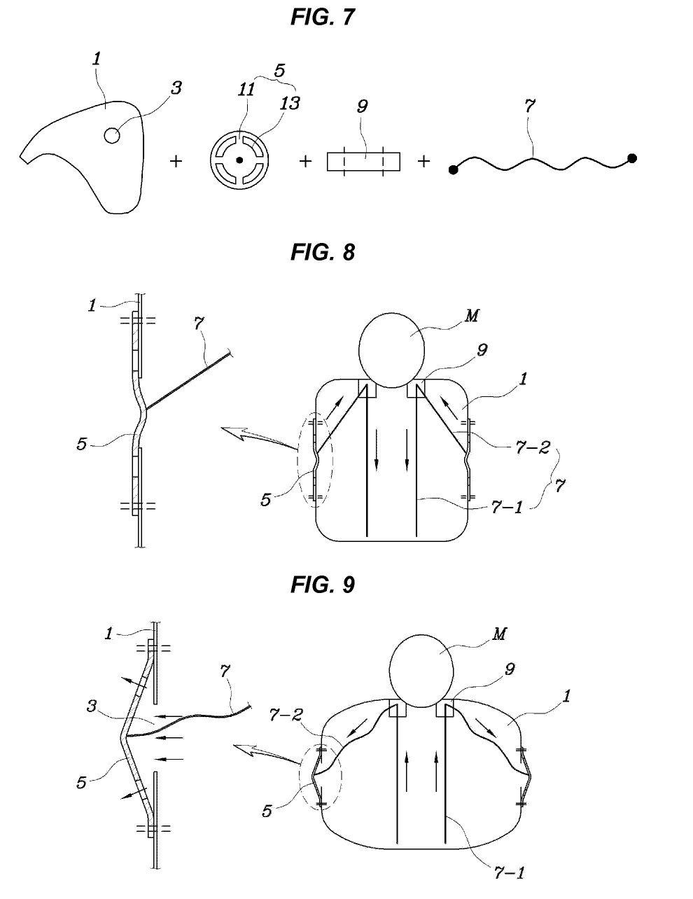

Referring to FIG. 1 to FIG. 10, embodiments of the present invention include: a vent hole 3 formed on an airbag cushion 1 for discharging an expanding gas inside of the airbag cushion 1, a cover 5 which is mounted apart from the vent hole 3 on the outside of the airbag cushion 1 and which is convertible between an opening state and closing state of the vent hole 3 by applied tensile force, a rope 7 one end of which is fixed to the inside of the airbag cushion 1 and the other end fixed to the cover 5 to provide a tensile force with the cover 5 through the vent hole 3, and a rope-guide 9 upholding the rope 7 to the airbag cushion 1 to slide and pass through the inside of the airbag cushion 1 longitudinally.

The vent hole 3 is located on the side of the airbag cushion 1, the rope 7 the other end of which is fixed on the front of the airbag cushion 1 and the rope guide 9 is mounted on the inner part of the airbag cushion 1 contacting an occupant's head M.

The both sides of a central part of the rope guide 9 may be sewed at the airbag cushion 1 with surrounding the rope 7 together with the inner part of the airbag.

In embodiments illustrated in FIG. 1 to FIG. 5, the cover 5 is formed of a pocket shaped outlet, a part of which is connected to the airbag cushion 1 and the other part is open to surround around the vent hole 3 so that expanding gas discharged from the vent hole 3 is released to air, together with the outer surface of the airbag cushion 1.

Herein, the cover 5 is shaped as a trapezoid of which a triangle is connected to both sides of a quadrangle so as to make a space for the quadrangle apart from the surface of the airbag cushion 1 by a triangle connected to the both sides of the quadrangle, and hypotenuses of the triangle which narrows toward the quadrangle and a side of the quadrangle connecting the hypotenuses surround around the vent hole 3 and are connected directly to the airbag cushion 1 and the other sides which the triangle and the quadrangle meet are freely open apart from the airbag cushion 1.

As illustrated in FIG. 3, the rope 7 is divided by a first part 7-1 connecting the front and the rear of the airbag cushion 1 and a second part 7-2 extended to the side of the airbag cushion 1 and connected to the cover 5 around a center of the rope guide 9. An open and close operation of the cover 5 is performed by a pressure of expanding gas inside the airbag cushion 1 and a relative length variations of the first part 7-1 and the second part 7-2 of the rope 7.

The airbag apparatus is configured such that the rear part of the airbag cushion 1 installed with the rope guide 9 proceeds backward to an occupant's head M at the beginning of the deployment of the airbag cushion 1 as shown in FIG. 3. At this time, the rope the second part 7-2 of which is pulled to move toward the first part 7-1 according to a relative movement of the rope guide 9 as indicated with an arrow so that the cover 5 makes the vent hole 3 to be closed and airbag cushion 1 is rapidly deployed at the beginning.

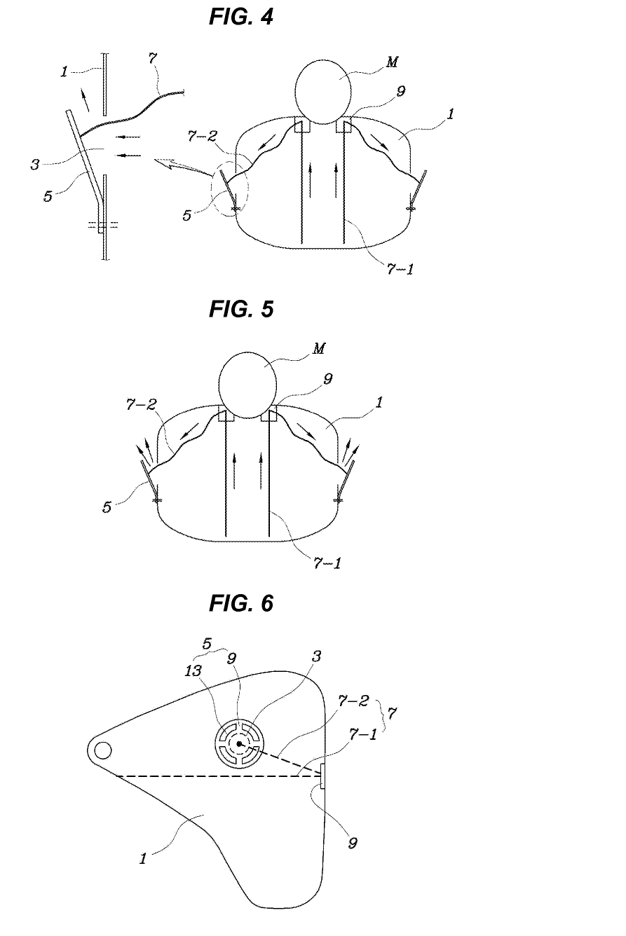

FIG. 4 shows a situation that an occupant's head M is loaded to the airbag cushion 1 after the deployment of the airbag cushion 1. As the occupant's head M pushes the rear part of the airbag cushion 1 forward, the rope guide 9 moves forward and expanding gas operates to force the cover 5 toward outside. Accordingly, the rope 7 the first part 7-1 of which is pulled and moved toward the second part 7-2 so that the second part 7-2 of the rope 7 is extended to allow the cover 5 to open the vent hole 3, thereby expanding gas inside of the airbag cushion 1 is discharged through the vent hole 3 so that an impact applied to the occupant from the airbag cushion 1 is loosened.

With this operation, the cover 5 closes the vent hole 3 so as to deploy the airbag cushion 1 rapidly at the beginning and the cover 5 opens the vent hole 3 so as to loosen the impact applied to the occupant when the occupant is loaded to the airbag cushion 1.

FIG. 5 is showing the LRD performance according to an exemplary embodiment of the present invention, even at the beginning of deployment of the airbag cushion 1, when a child's . head M is loaded to the airbag cushion 1, the part to which the rope guide 9 is installed moves toward the front of the airbag cushion 1, which allows the first part 7-1 of the rope 7 to be moved toward the second part 7-2. As a result, the length of the second part 7-2 is extended enough to allow expanding gas to open the cover 5 so as to discharge expanding gas, thereby implements a proper LRD performance to protect the child effectively.

Furthermore, the airbag apparatus according to an exemplary embodiment of the present invention is expected to implement an effective loosening operation whether the occupant is fastened with a seat belt or is not fastened with a seat belt when an accident occurs.

That is, when the occupant is fastened with a seat belt when an accident occurs, the airbag cushion 1 the part of which the occupant becomes to contact is the part to which the rope guide 9 is installed as originally designed so that through a relatively rapid operation thereof the cover 5 is open and airbag cushion get soft to effectively loosen the impact applied to the occupant, which has been reduced by the seat belt at first. On the contrary, when the occupant is not fastened with a seat when an accident occurs, the airbag cushion 1 the part of which the occupant becomes to contact gets off the part to which the rope guide 9 is installed so that through a relatively slow operation thereof the cover 5 is open later and airbag cushion 1 get relatively hard to loosen the impact applied to the occupant while supporting relatively strongly the occupant who has not been loosened by the seat belt. Accordingly, it provides suitable loosening performance depending on the case that the occupant is fastened with a seat belt or is not fastened with a seat belt.

FIGS. 6 to 9 are views showing the cover is different from above exemplary embodiments wherein the cover 5 includes a central part 13 formed larger than the vent hole 3 and a plurality of legs 11 connected to the airbag cushion 1 for connecting the central part to the outer surface of the airbag cushion 1 and expanding gas discharged from the vent hole 3 is released through space formed between the legs 11.

Of course, one end of the rope 7 is connected to the inner surface of the central part 13 of the cover 5 and the other end of the rope 7 is fixed to the inner part of the airbag cushion 1 and upheld by the rope guide 9 so as to be operated as the same principle of the above exemplary embodiments.

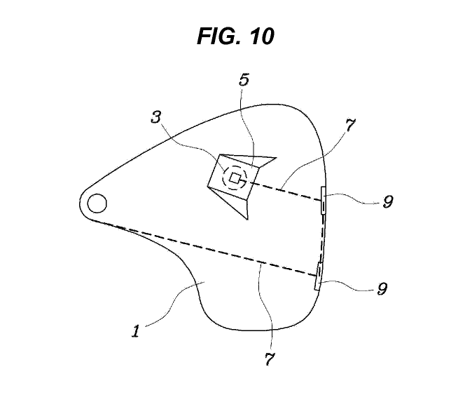

Meanwhile, FIG. 10 is showing another exemplary embodiment of the present invention, a plurality of the rope guides 9 are mounted on each other positions of the airbag cushion 1 to surround and uphold the rope 7.

The rope guide 9 may be installed on a position where an occupant's head M is in contact with the airbag cushion 1 and at a lowering part of the contacting part, respectively. For example, the rope guide 9 may be mounted on the positions of the airbag cushion where an usual adult's head M sitting normally contacts the airbag cushion 1 and where an usual child's head M sitting normally contacts the airbag cushion, respectively.

Through this configuration of the airbag apparatus, it implements the LRD performance surely since not only it rapidly performs the deployment of the airbag cushion 1 at the beginning and the loosening of the impact when the occupant is loaded, in case a normal adult sits, but also when a child sits, the child's head M allows the lower part of the rope guide 9 to be moved toward the airbag cushion 1.

The present invention provides an airbag apparatus of a vehicle with low cost and simple configuration, which is deployed rapidly at the beginning, satisfies proper loosening performance when occupant is loaded to the airbag cushion and satisfies the LRD performance to reduce damage to a child or occupant who is nearly located to the airbag.

For convenience in explanation and accurate definition in the appended claims, the terms “upper”, “lower”, “inner”, “outer”, “forwards” and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An airbag apparatus for a vehicle comprising:
a vent hole formed on an airbag cushion to discharge an expanding gas inside of the airbag cushion;
a cover attached on the outside of the airbag and selectively covering the vent hole;
a rope, one end of which is fixed to the inside of the airbag cushion and the other end of which is fixed to the cover through the vent hole to provide a tensile force to the cover such that the cover opens or closes the vent hole according to the tensile force applied to the cover via the rope; and
a rope-guide attached to the inside of the airbag cushion and upholding the rope to the airbag cushion, wherein the rope is slidably engaged to the rope-guide and a section of the rope is aligned longitudinally in the airbag cushion.

2. The airbag apparatus for the vehicle of claim 1, wherein the one end of the rope is fixed on a front of the airbag cushion, and the rope guide is mounted on a rear of the airbag cushion on the inside of the airbag cushion such that an occupant's head is in contact with the rear of the airbag cushion.

3. The airbag apparatus for the vehicle of claim 1, wherein both sides of the rope guide are sewed at the airbag cushion with slidably surrounding the rope between the both sides and an inner surface of the airbag together.

4. The airbag apparatus for the vehicle of claim 1, wherein the cover is shaped of a pocket, a part of which is connected to the airbag cushion and the other part is disconnected from the airbag cushion so that the expanding gas discharged from the vent hole is released to the outside of the airbag cushion through the pocket.

5. The airbag apparatus for the vehicle of claim 4, wherein the cover is shaped of a trapezoid of which a triangle is connected to both sides of a quadrangle so as to make a space for the quadrangle apart from an outer surface of the airbag cushion by a triangle connected to the both sides of the quadrangle; and hypotenuses of the triangle which narrows toward the quadrangle and a side of the quadrangle connecting the hypotenuses surround around the vent hole and are connected directly to the airbag cushion and the other sides which the triangle and the quadrangle meet are freely open apart from the airbag cushion.

6. The airbag apparatus for the vehicle of claim 1, wherein the cover includes:
a central part formed larger than the vent hole and covering the vent hole; and
a plurality of legs connecting the central part to an outer surface of the airbag cushion, wherein the expanding gas discharged from the vent hole is released through space formed between the legs.

7. The airbag apparatus for the vehicle of claim 6, wherein the other end of the rope is connected to an inner surface of the central part of the cover through the vent hole.

8. The airbag apparatus for the vehicle of claim 1, wherein a plurality of the rope guides are mounted on the different positions of the airbag cushion to surround and slidably uphold the rope.

9. The airbag apparatus for the vehicle of claim 8,
wherein at least two rope guides of the rope guides are mounted on a rear of the airbag cushion, and
wherein one of the at least two rope guides is positioned above another of the at least two rope guides.

10. The airbag apparatus for the vehicle of claim 9, wherein the one of the at least two rope guides is mounted on a position of the airbag cushion where a usual adult's head M sitting contacts and the another of the at least two rope guides is mounted on a position of the airbag cushion where a usual child's head M sitting contacts respectively.
